(19) United States
(12) Patent Application Publication
(10) Pub. No.: US 2023/0119062 A1
(43) Pub. Date: Apr. 20, 2023

(54) LADDER

(71) Applicant: Jiangsu Zhou Jijie Intelligent Technology Co., Ltd, Suqian (CN)

(72) Inventors: Xuelin ZHU, Suqian (CN); Baisong YAO, Suqian (CN); Weiqiang LIU, Suqian (CN)

(73) Assignee: Jiangsu Zhou Jijie Intelligent Technology Co., Ltd, Suqian (CN)

(21) Appl. No.: 17/582,006

(22) Filed: Jan. 24, 2022

(30) Foreign Application Priority Data
Oct. 18, 2021 (CN) 202122507873.X

(51) Int. Cl. E06C 1/14; E06C 7/18; E06C 1/383

(52) U.S. Cl. CPC E06C 1/14; E06C 7/181; E06C 1/3835

(57) ABSTRACT

A ladder is provided. The ladder includes a ladder frame, wherein on the ladder frame foot boards are disposed, wherein the ladder frame includes a front bracket and a back bracket; the front bracket is provided with fixing joints; a handrail collapsible by sliding or overturning is disposed on the fixing joints; collapsing/unfolding structures for collapsing or unfolding the handrail are disposed between the fixing joints and the handrail; and after the ladder frame and the handrail are collapsed, a footprint of the handrail in a thickness direction is not more than a footprint of the fixing joints. By disposing the fixing joints to mount the handrail for providing a clearance space to collapse the handrail, the handrail is collapsed, by sliding or overturning, to an inner side of the ladder frame without increasing a footprint of a wholly collapsed ladder.

### CROSS REFERENCE TO THE RELATED APPLICATIONS

This application is based upon and claims priority to Chinese Patent Application No. 202122507873.X filed on Oct. 18, 2021, the entire contents of which are incorporated herein by reference.

### TECHNICAL FIELD

The present invention belongs to the technical field of ladders, and in particular, relates to a ladder with a handrail.

### BACKGROUND

Ladders are tools for climbing up. A ladder has two long thick rods as fixed sides, and cross rods for stepping are transversely and penetratively disposed between the two long thick rods. The ladder can be seen everywhere in life and has been extensively applied. For different usage occasions and different usage requirements, the ladder has been gradually evolved from the simplest structure, and many practical functions have been added. For example, a foldable ladder has been developed and produced for the convenience of storage. The foldable ladder is unfolded when in use and can be folded and stored after use, with a small footprint. The foldable ladder has to be solid and firm in workmanship in order to ensure good supporting performance during unfolding and simultaneously ensure safety and reliability.

To increase the safety of the ladder in use, a handrail for a user to use is added to a ladder frame of the foldable ladder in the prior art. However, the handrail in the existing foldable ladder is generally noncollapsible, or the handrail after being collapsed obviously increases the overall footprint of the collapsed ladder, which is inconvenient for a user to carry and store.

### SUMMARY

In view of the above problems existing in the prior art, an objective of the present invention is to provide a ladder with a small footprint in a collapsed state.

The objective of the present invention can be achieved by the following technical solution: a ladder includes a ladder frame, on which foot boards are disposed, wherein the ladder frame includes a front bracket and a back bracket; the front bracket is provided with fixing joints; a handrail that is collapsible by sliding or overturning is disposed on the fixing joints; collapsing/unfolding structures for collapsing or unfolding the handrail are disposed between the fixing joints and the handrails; and after the ladder frame and the handrail are collapsed, a footprint of the handrail in a thickness direction is not more than a footprint of the fixing joints.

By disposing the fixing joints to mount the handrail for providing a clearance space to collapse the handrail, the handrail can be collapsed, by sliding or overturning, to an inner side of the ladder frame without increasing the footprint of the wholly collapsed ladder, which is convenient for a user to carry and store; and the collapsing/unfolding structures are configured to coordinate with the sliding or overturning of the handrail.

In the ladder defined above, each of the fixing joints is provided with a movable opening for allowing the handrail to be overturned and collapsed; the handrail is provided with connecting joints at both sides respectively; and the connecting joints are respectively articulated within the movable openings of the fixing joints.

By disposing the movable openings on the fixing joints to provide a clearance for collapsing the handrail, the connecting joints at both sides of the handrail are articulated with the movable openings to rotate and collapse the handrail.

In the ladder defined above, the collapsing/unfolding structures include sleeves sleeved on the connecting joints and the fixing joints, springs disposed between the connecting joints and the sleeves, and first locking-up structures disposed between the sleeves and the connecting joints and capable of limiting the runout of the sleeves; and when the handrail is overturned into a collapsed state, both ends of the springs are butted against the connecting joints and the movable openings respectively.

By disposing the sleeves on the connecting joints and the fixing joints to coordinate with the first locking-up structures, the connecting joints and the fixing joints can be connected, and the springs limit the sleeves to prevent the sleeves from shaking during the collapsing of the handrail.

In the ladder defined above, each of the first locking structures includes a limiting slot disposed on the respective connecting joint, a limiting pin disposed in the limiting slot, and a locking-up slot disposed on the respective sleeve; the locking-up slots are I-shaped; and the limiting pins can penetrate out of the limiting slots and into one of both ends of the locking-up slots for locking-up.

Since the locking-up slots are I-shaped, the sleeves can be rotated to allow the locking-up slots to rotate along therewith, thereby unlocking the locking-up pins from one ends of the I-shaped locking-up slots. Here, the limiting pins do not limit the locking-up slots any more, and the sleeves can be overturned downwards and collapsed, until the limiting pins enter the other ends of the I-shaped locking-up slots. Here, the sleeves can be rotated again to lock the limiting pins.

In the ladder defined above, as another solution, the handrail is articulated on surfaces of the fixing joints at the inner side of the ladder frame. By articulating the handrail with the fixing joints, the handrail can be rotated and collapsed.

In the ladder defined above, the collapsing/unfolding structures include second locking-up structures disposed between the handrail and the fixing joints, and limiting structures disposed on the fixing joints; the second locking-up structures can limit the collapsed handrail; and the limiting structures can limit the unfolded handrail. The second locking-up structures are intended for preventing the collapsed handrail from restoring movement; and the limiting structures are intended for preventing the collapsing of the handrail.

In the ladder defined above, each of the second locking-up structures includes a locking-up member disposed between the respective handrail and the respective fixing joint and capable of limiting the rotation of the respective handrail, and a torsional spring capable of limiting the rotation of the locking-up member. The handrail can be rotated and unfolded only by overcoming the elastic force of the torsional springs, thereby preventing the handrail from shaking during collapsing.

In the ladder defined above, each of the limiting structures includes a fixing pin disposed on the respective fixing joint, and a limiting hole disposed on the respective handrail to match the fixing pin; and the handrail when unfolded is hangable against the fixing pins via the limiting holes.

By disposing the limiting holes and the fixing pins, the handrail can be prevented from rotating clockwise, thereby ensuring the stability of the handrail in the unfolded state.

In the ladder defined above, as another solution, the handrail is slidably connected to surfaces of the fixing joints close to the inner side of the ladder frame. By slidably connecting the handrail to the fixing joints, the handrail can be collapsed by sliding.

In the ladder defined above, the collapsing/unfolding structures include sliding chutes disposed on the fixing joints, and sliding members disposed on the sliding chutes and slidably connected thereto; and the sliding members are further connected to the handrail. By connecting the handrail to the sliding members, sliding the handrail can drive the sliding members to slide on the sliding chutes.

In the ladder defined above, as another solution, the collapsing/unfolding structures include sliding chutes disposed on the fixing joints, sliding members disposed on the sliding chutes and slidably connected thereto, and cover plates disposed between the sliding chutes and the handrail for preventing the sliding members from sliding off; and the sliding members are further connected to the handrail. By adding the cover plates, the sliding chutes and the sliding members can be protected against outside interferences.

In the ladder defined above, the sliding chutes are provided with limiting corners for restricting the handrail from sliding down and collapsing. By disposing the limiting corners to prevent the accidental sliding-off of the handrail in the unfolded state, the stability of the handrail is increased in the unfolded state, and the limiting force of the limiting corners needs to be overcome to slide and collapse the handrail.

In the ladder defined above, the ladder frame is further provided with a protective structure for preventing a user from slipping off. By disposing the protective structure, the safety of the ladder can be increased.

In the ladder defined above, the protective structure includes a protective rod articulated to the ladder frame at one side and a limiting member disposed on the other side of the ladder frame; and the protective rod can be rotated and buckled on the limiting member.

By articulating the protective rod to the ladder frame, the protective rod can be rotated and used, and the rotated protective rod is buckled with the limiting member, which increases the stability.

In the ladder defined above, the handrail is internally provided with a reinforcing pipe. By disposing the reinforcing pipe, the strength of the handrail is reinforced.

Compared with the prior art, in the present invention, by disposing the fixing joints to mount the handrail for providing a clearance space to collapse the handrail, the handrail can be collapsed, by sliding or overturning, to an inner side of the ladder frame without increasing the footprint of the wholly collapsed ladder, which is convenient for a user to carry and store; the collapsing/unfolding structures are disposed to coordinate with the sliding or overturning of the handrail; the shaking of the collapsed handrail can be prevented by disposing the first or second locking-up structures; the stable unfolding of the handrail is ensured by disposing the limiting structures or limiting corners; the safety of the ladder can be increased by disposing the protective structure; and the strength of the handrail is reinforced by disposing the reinforcing pipe.

### BRIEF DESCRIPTION OF THE DRAWINGS

FIG. 1 is a schematic structural stereogram of Embodiment 1 according to the present invention;

FIG. 2 is a schematic structural stereogram of Embodiment 1 in a collapsed state according to the present invention;

FIG. 3 is a schematic enlarged view of a partial structure in FIG. 2;

FIG. 4 is a schematic structural stereogram of Embodiment 2 according to the present invention;

FIG. 5 is a first schematic structural stereogram of Embodiment 2 in a collapsed state according to the present invention;

FIG. 6 is a second schematic structural stereogram of Embodiment 2 in a collapsed state according to the present invention;

FIG. 7 is a schematic structural stereogram of Embodiment 3 according to the present invention;

FIG. 8 is a first schematic structural stereogram of Embodiment 3 in a collapsed state according to the present invention;

FIG. 9 is a second schematic structural stereogram of Embodiment 3 in a collapsed state according to the present invention; and

FIG. 10 is a schematic structural stereogram of Embodiment 4 according to the present invention.

In the figures, references signs are as follows: 1, ladder frame; 11, front bracket; 12, back bracket; 2, foot board; 3, fixing joint; 4, handrail; 5, collapsing/unfolding structure; 51, sleeve; 52, sprint; 53, first locking-up structure; 531, limiting slot; 532, limiting pin; 533, locking-up slot; 54, second locking-up structure; 541, locking-up member; 542, torsional spring; 55, limiting structure; 551, fixing pin; 552, limiting hole; 56, sliding chute; 57, sliding member; 58, cover plate; 59, limiting corner; 6, movable opening; 7, connecting joint; 8, protective structure; 81, protective rod; 82, limiting member; and 9, reinforcing pipe.

### DETAILED DESCRIPTION OF THE EMBODIMENTS

The following are the specific embodiments of the present invention, and the technical solutions of the present invention will be further described below in conjunction with the accompanying drawings. However, the present invention is not limited to these embodiments.

Embodiment 1

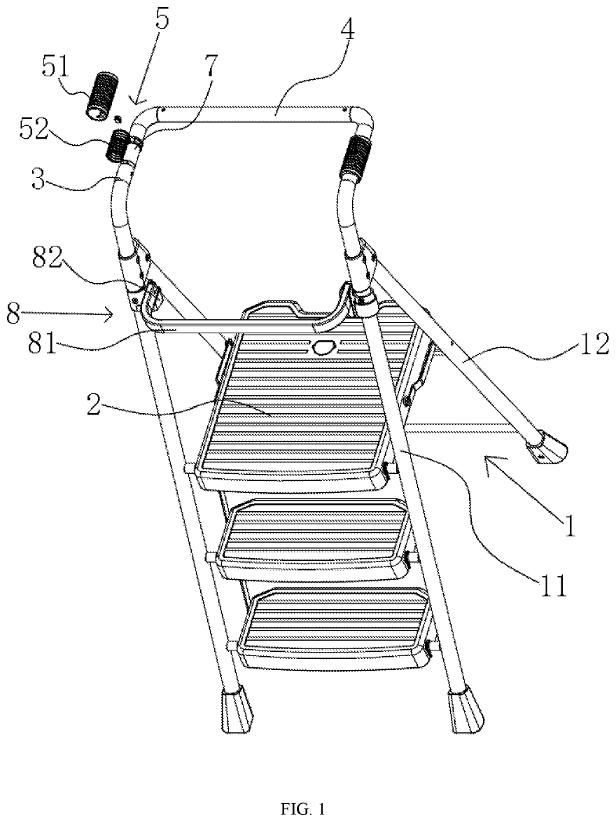

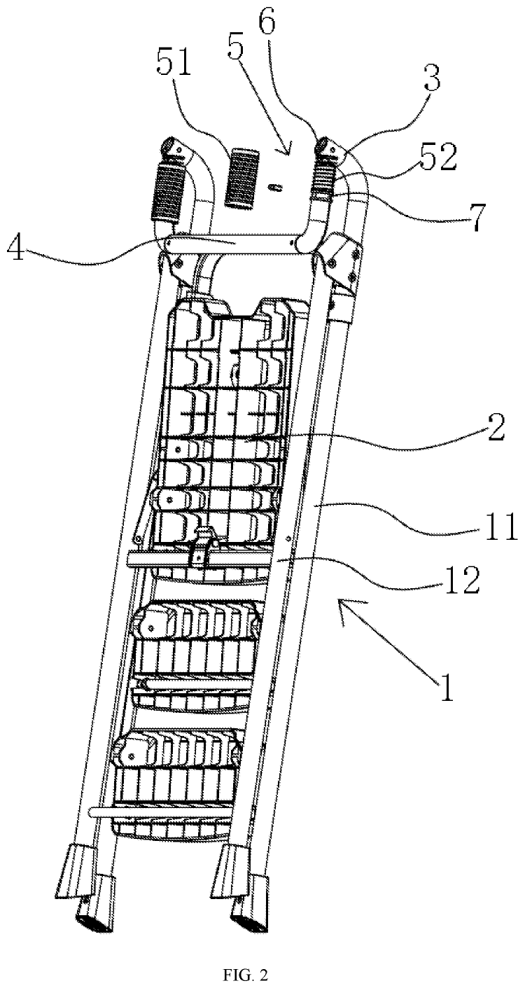

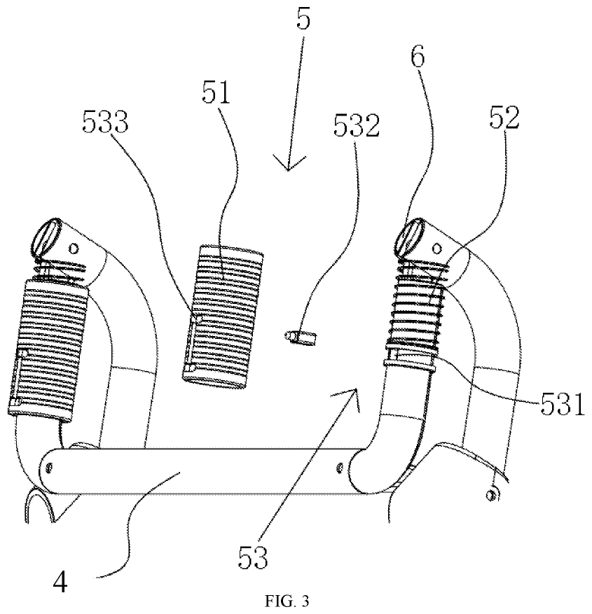

As shown in FIGS. 1 to 3, in this embodiment a ladder includes a ladder frame 1, on which foot boards 2 are disposed, wherein the ladder frame 1 includes a front bracket 11 and a back bracket 12; the front bracket 11 is provided with fixing joints 3; a handrail 4 that is collapsible by sliding or overturning is disposed on the fixing joints 3; collapsing/unfolding structures 5 for collapsing or unfolding the handrail 4 are disposed between the fixing joints 3 and the handrail 4; and after the ladder frame 1 and the handrail 4 are collapsed, a footprint of the handrail 4 in a thickness direction is not more than a footprint of the fixing joints 3.

By disposing the fixing joints 3 to mount the handrail 4 for providing a clearance space to collapse the handrail 4, the handrail 4 can be collapsed, by sliding or overturning, to an inner side of the ladder frame 1 without increasing the footprint of the wholly collapsed ladder, which is convenient for a user to carry and store; and the collapsing/unfolding structures 5 are configured to coordinate with the sliding or overturning of the handrail 4.

Each of the fixing joints 3 is provided with a movable opening 6 for allowing the handrail 4 to be overturned and collapsed; the handrail 4 is provided with connecting joints 7 at both sides respectively; and the connecting joints 7 are respectively articulated within the movable openings 6 of the fixing joints 3. By disposing the movable openings 6 on the fixing joints 3 to provide a clearance for collapsing the handrail 4, the connecting joints 7 at both sides of the handrail 4 are articulated with the movable openings 6 to rotate and collapse the handrail 4.

The collapsing/unfolding structures 5 include sleeves 51 sleeved on the connecting joints 7 and the fixing joints 3, springs 52 disposed between the connecting joints 7 and the sleeves 51, and first locking-up structures 53 disposed between the sleeves 51 and the connecting joints 7 and capable of limiting the runout of the sleeves 51; and when the handrail 4 is overturned into a collapsed state, both ends of the springs 52 are butted against the connecting joints 7 and the movable openings 6 respectively. By disposing the sleeves 51 on the connecting joints 7 and the fixing joints 3 to coordinate with the first locking-up structures 53, the connecting joints 7 and the fixing joints 3 can be connected, and the springs 52 limit the sleeves 51 to prevent the sleeves 51 from shaking during the collapsing of the handrail 4.

Each of the first locking structures 53 includes a limiting slot 531 disposed on the respective connecting joint 7, a limiting pin 532 disposed in the limiting slot 531, and a locking-up slot 533 disposed on the respective sleeve 51; the locking-up slots 533 are I-shaped; and the limiting pins 532 can penetrate out of the limiting slots 531 and into one of both ends of the locking-up slots 533 for locking-up. Since the locking-up slots 533 are I-shaped, the sleeves 51 can be rotated to allow the locking-up slots 533 to rotate along therewith, thereby unlocking the locking-up pins 532 from one ends of the I-shaped locking-up slots 533. Here, the limiting pins 532 do not limit the locking-up slots 533 any more, and the sleeves 51 can be overturned downwards and collapsed, until the limiting pins 532 enter the other ends of the I-shaped locking-up slots 533. Here, the sleeves 51 can be rotated again to lock the limiting pins 532.

The ladder frame 1 is further provided with a protective structure 8 for preventing a user from slipping off. By disposing the protective structure 8, the safety of the ladder can be increased. The protective structure 8 includes a protective rod 81 articulated to the ladder frame 1 at one side and a limiting member 82 disposed on the other side of the ladder frame 1; and the protective rod 81 can be rotated and buckled on the limiting member 82. By articulating the protective rod 81 to the ladder frame 1, the protective rod 81 can be rotated and used, and the rotated protective rod 81 is buckled with the limiting member 82, which increases the stability. The handrails 4 are internally provided with reinforcing pipes 9. By disposing the reinforcing pipe 9, the strength of the handrail 4 is reinforced.

Embodiment 2

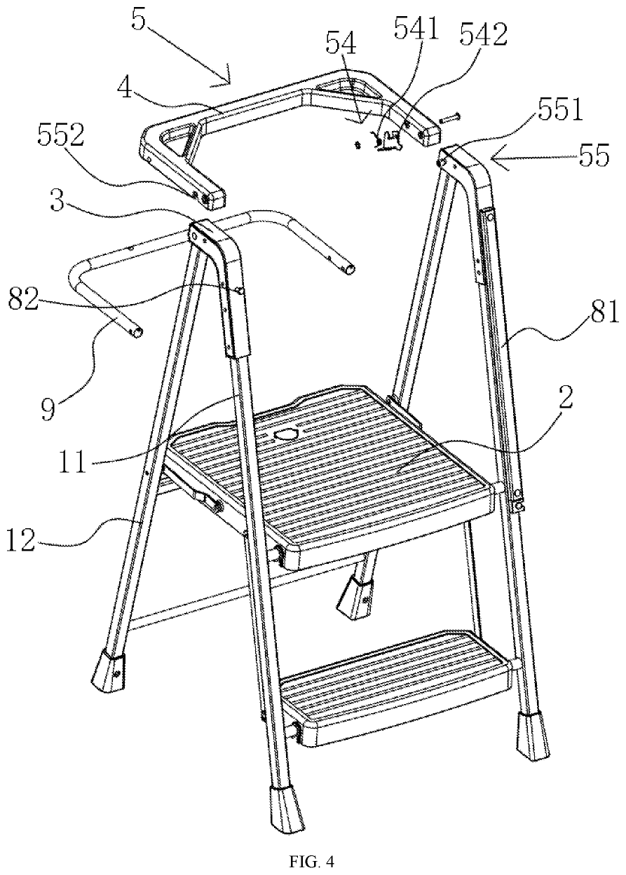

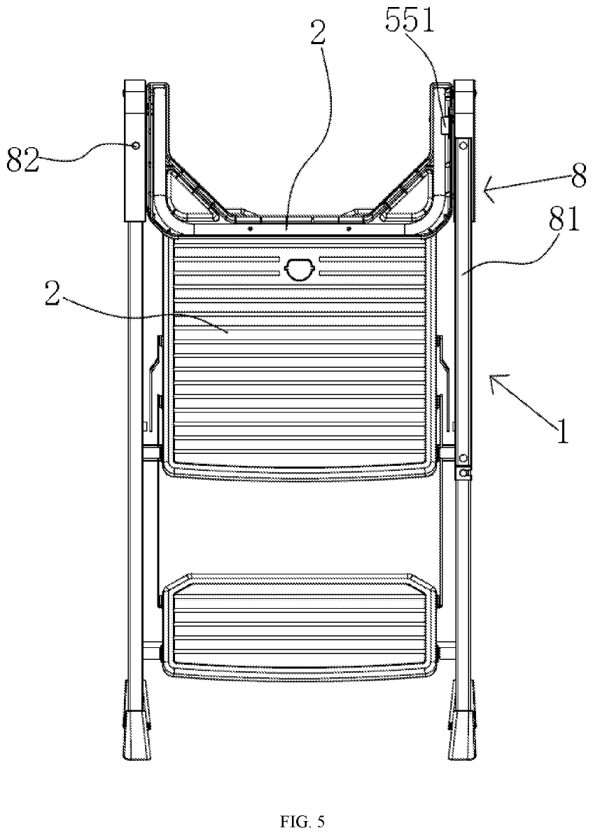

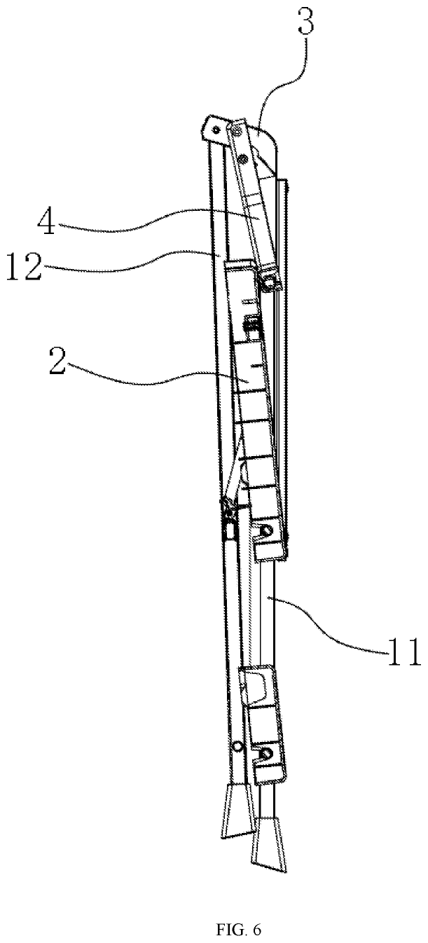

As shown in FIGS. 4 to 6, this embodiment is basically the same as Embodiment 1 in structure and principle, but with a difference that the handrail 4 is articulated to surfaces of the fixing joints 3 at an inner side of the ladder frame 1. By articulating the handrail 4 with the fixing joints 3, the handrail 4 can be rotated and collapsed.

The collapsing/unfolding structures 5 include second locking-up structures 54 disposed between the handrail 4 and the fixing joints 3, and limiting structures 55 disposed on the fixing joints 3; the second locking-up structures 54 can limit the collapsed handrail 4; and the limiting structures 55 can limit the unfolded handrail 4. The second locking-up structures 54 are intended for preventing the collapsed handrail 4 from restoring movement; and the limiting structures 55 are intended for preventing the collapsing of the handrail 4.

Each of the second locking-up structures 54 includes a locking-up member 541 disposed between the respective handrail 4 and the respective fixing joint 3 and capable of limiting the rotation of the respective handrail 4, and a torsional spring 542 capable of limiting the rotation of the locking-up member 541. The handrail 4 can be rotated and unfolded only by overcoming the elastic force of the torsional springs 542, thereby preventing the handrail 4 from shaking during collapsing.

Each of the limiting structures 55 includes a fixing pin 551 disposed on the respective fixing joint 3, and a limiting hole 552 disposed on the respective handrail 4 to match the fixing pin 551; and the handrail 4 when unfolded is hangable against the fixing pins 551 via the limiting holes 552. By disposing the limiting holes 552 and the fixing pins 551, the handrail 4 can be prevented from rotating clockwise, thereby ensuring the stability of the handrail 4 in the unfolded state.

Embodiment 3

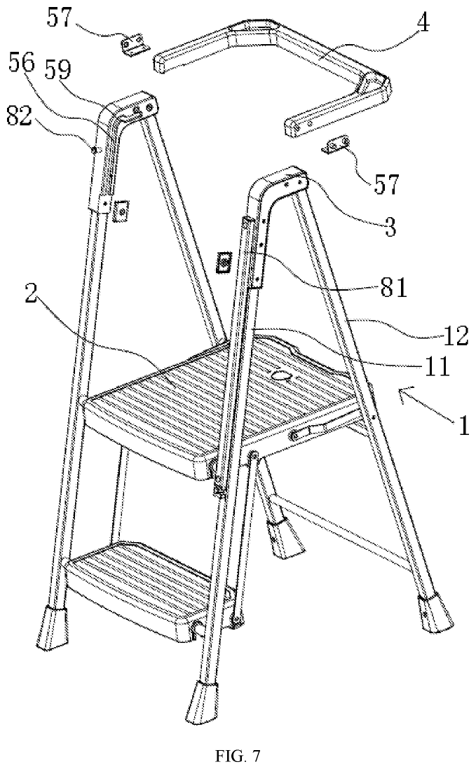

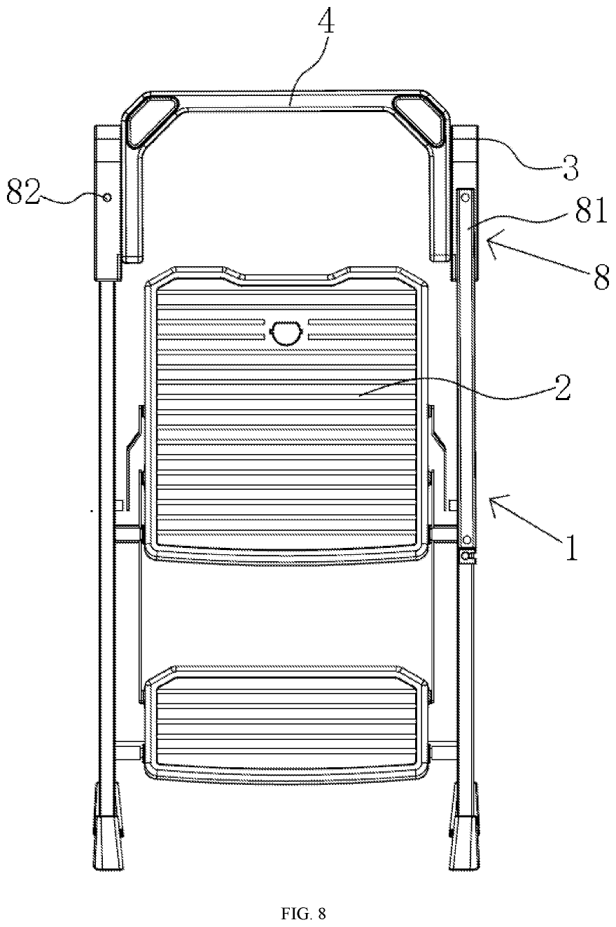

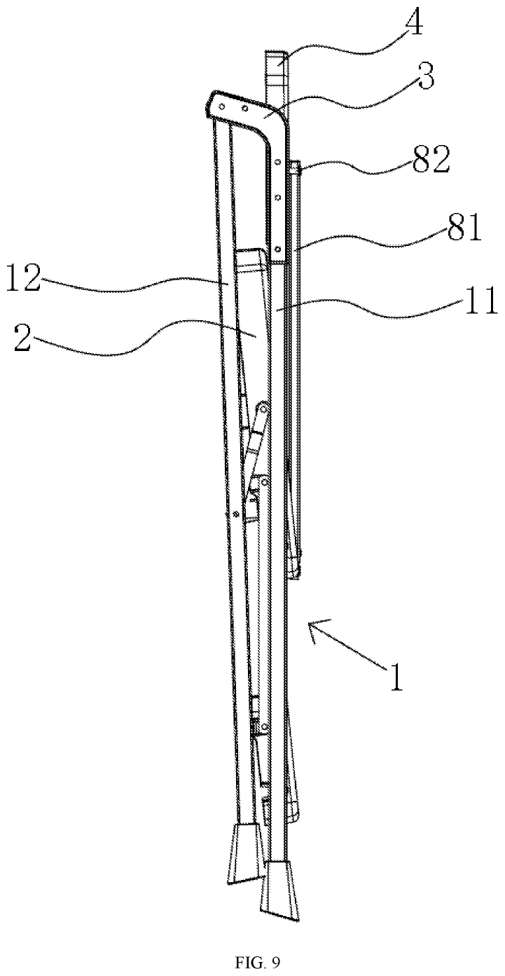

As shown in FIGS. 7 to 9, this embodiment is basically the same as Embodiment 2 in structure and principle, but with a difference that the handrail 4 is slidably connected to surfaces of the fixing joints 3 close to the inner side of the ladder frame 1. By slidably connecting the handrail 4 to the fixing joints 3, the handrail 4 can be collapsed by sliding.

The collapsing/unfolding structures 5 include sliding chutes 56 disposed on the fixing joints 3, and sliding members 57 disposed on the sliding chutes 56 and slidably connected thereto; and the sliding members 57 are further connected to the handrail 4. By connecting the handrail 4 to the sliding members 57, sliding the handrail 4 can drive the sliding members 57 to slide on the sliding chutes 56.

The sliding chutes 56 are provided with limiting corners 59 for restricting the handrail 4 from sliding down and collapsing. By disposing the limiting corners 59 to prevent the accidental sliding-off of the handrail 4 in the unfolded state, the stability of the handrail 4 is increased in the unfolded state, and the limiting force of the limiting corners 59 needs to be overcome to slide and collapse the handrail 4.

Embodiment 4

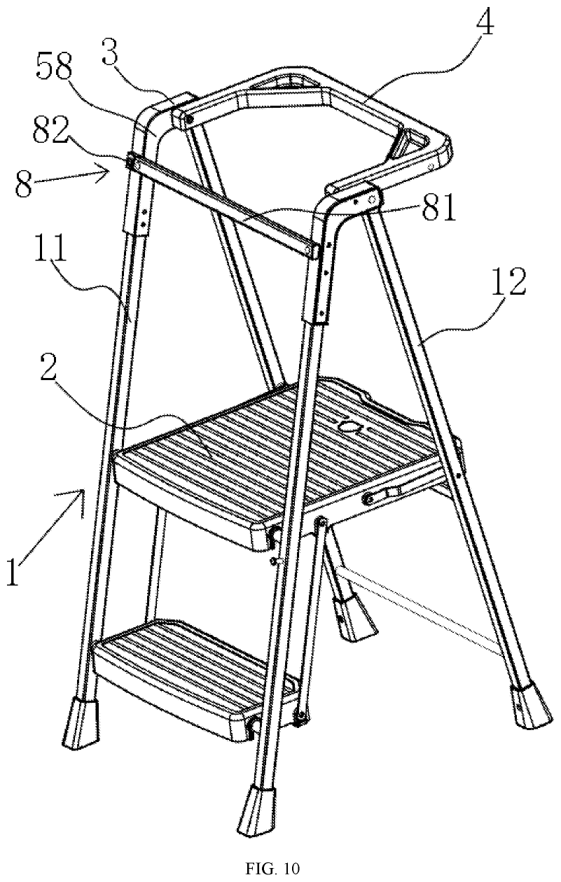

As shown in FIG. 10, this embodiment is basically the same as Embodiment 3 in structure and principle, but with differences that the collapsing/unfolding structures 5 include sliding chutes 56 disposed on the fixing joints 3, sliding members 57 disposed on the sliding chutes 56 and slidably connected thereto, and cover plates 58 disposed between the sliding chutes 56 and the handrail 4 for preventing the sliding members 57 from sliding off; and the sliding members 57 are further connected to the handrail 4. By adding the cover plates 58, the sliding chutes 56 and the sliding members 57 can be protected against outside interferences.

In the present invention, by disposing the fixing joints 3 to mount the handrail 4 for providing a clearance space to collapse the handrail 4, the handrail 4 can be collapsed, by sliding or overturning, to an inner side of the ladder frame 1 without increasing the footprint of the wholly collapsed ladder, which is convenient for a user to carry and store;

the collapsing/unfolding structures 5 are disposed to coordinate with the sliding or overturning of the handrail 4; the shaking of the collapsed handrail 4 can be prevented by disposing the first locking-up structures 53 or the second locking-up structures 54; the stable unfolding of the handrail 4 is ensured by disposing the limiting structures 55 or the limiting corners 59; the safety of the ladder can be increased by disposing the protective structure 8; and the strength of the handrail 4 is reinforced by disposing the reinforcing pipe 9.

The specific embodiments described herein are only intended to exemplify the spirit of the present invention. Those skilled in the art to which the present invention belongs may make a variety of modifications or supplements or substitutions in a similar way to the specific embodiments as described, which is deemed as not departing from the spirit of the present invention or not going beyond the scope defined by the accompanying claims.

What is claimed is:

1. A ladder, comprising a ladder frame, wherein foot boards are disposed on the ladder frame, wherein the ladder frame comprises a front bracket and a back bracket; the front bracket is provided with fixing joints; a handrail collapsible by sliding or overturning is disposed on the fixing joints; collapsing/unfolding structures for controlling a collapsing and unfolding of the handrail are disposed between the fixing joints and the handrail; and
after the ladder frame and the handrail are collapsed, a footprint of the handrail in a thickness direction is not more than a footprint of the fixing joints in the thickness direction.

2. The ladder according to claim 1, wherein each of the fixing joints is provided with a movable opening for allowing the handrail to be overturned and collapsed; the handrail is provided with connecting joints at both sides respectively; and the connecting joints are respectively articulated within the movable openings of the fixing joints.

3. The ladder according to claim 2, wherein the collapsing/unfolding structures comprise sleeves sleeved on the connecting joints and the fixing joints, springs disposed between the connecting joints and the sleeves, and first locking-up structures disposed between the sleeves and the connecting joints and the first locking-up structures are configured for limiting a runout of the sleeves; and when the handrail is overturned into a collapsed state, both ends of the springs are butted against the connecting joints and the movable openings respectively.

4. The ladder according to claim 3, wherein each of the first locking-up structures comprises a limiting slot disposed on a respective connecting joint, a limiting pin disposed in the limiting slot, and a locking-up slot disposed on a respective sleeve; the locking-up slots are I-shaped; and the limiting pins penetrate out of the limiting slots and into one of both ends of the locking-up slots for locking-up.

5. The ladder according to claim 1, wherein the handrail is articulated on surfaces of the fixing joints at an inner side of the ladder frame.

6. The ladder according to claim 5, wherein the collapsing/unfolding structures comprise second locking-up structures disposed between the handrail and the fixing joints, and limiting structures disposed on the fixing joints; the second locking-up structures limit the handrail in a collapsed state; and the limiting structures limit the handrail in an unfolded state.

7. The ladder according to claim 6, wherein each of the second locking-up structures comprises a locking-up member disposed between the handrail and a respective fixing joint and the locking-up member is configured for limiting a rotation of the handrail, and a torsional spring is configured for limiting a rotation of the locking-up member.

8. The ladder according to claim 6, wherein each of the limiting structures comprises a fixing pin disposed on the respective fixing joint, and a limiting hole disposed on the handrail to match the fixing pin; and the handrail in the unfolded state is hangable against the fixing pins via the limiting holes.

9. The ladder according to claim 1, wherein the handrail is slidably connected to surfaces of the fixing joints close to the ladder frame.

10. The ladder according to claim 9, wherein the collapsing/unfolding structures comprise sliding chutes disposed on the fixing joints, and sliding members disposed on the sliding chutes and slidably connected to the sliding chutes; and the sliding members are further connected to the handrail.

11. The ladder according to claim 9, wherein the collapsing/unfolding structures comprise sliding chutes disposed on the fixing joints, sliding members disposed on the sliding chutes and slidably connected to the sliding chutes, and cover plates disposed between the sliding chutes and the handrail for preventing the sliding members from sliding off; and the sliding members are further connected to the handrail.

12. The ladder according to claim 10, wherein the sliding chutes are provided with limiting corners for restricting the handrail from sliding down and collapsing.

13. The ladder according to claim 1, wherein the ladder frame is further provided with a protective structure for preventing a user from slipping off.

14. The ladder according to claim 13, wherein the protective structure comprises a protective rod articulated to the ladder frame at a first side of the ladder frame and a limiting member disposed on a second side of the ladder frame; and the protective rod is rotated and buckled on the limiting member.

15. The ladder according to claim 1, wherein the handrail is internally provided with a reinforcing pipe.

16. The ladder according to claim 11, wherein the sliding chutes are provided with limiting corners for restricting the handrail from sliding down and collapsing.

17. The ladder according to claim 2, wherein the ladder frame is further provided with a protective structure for preventing a user from slipping off.

18. The ladder according to claim 3, wherein the ladder frame is further provided with a protective structure for preventing a user from slipping off.

19. The ladder according to claim 4, wherein the ladder frame is further provided with a protective structure for preventing a user from slipping off.

20. The ladder according to claim 5, wherein the ladder frame is further provided with a protective structure for preventing a user from slipping off.
